(19) United States
(12) Patent Application Publication
(10) Pub. No.: US 2020/0386950 A1
(43) Pub. Date: Dec. 10, 2020

(54) OPTICAL FIBER CONNECTION SYSTEM

(71) Applicant: 3M INNOVATIVE PROPERTIES COMPANY, St. Paul, MN (US)

(72) Inventors: Richard L. Simmons, Austin, TX (US); Nathaniel S. Shonkwiler, Austin, TX (US); Donald K. Larson, Cedar Park, TX (US); William J. Clatanoff, Austin, MN (US)

(21) Appl. No.: 16/644,596

(22) PCT Filed: Oct. 15, 2018
(86) PCT No.: PCT/IB2018/057975

§ 371 Date: Mar. 5, 2020

Related U.S. Application Data
(60) Provisional application No. 62/573,946, filed on Oct. 18, 2017.

(51) Int. Cl. G02B 6/38

(52) U.S. Cl. CPC G02B 6/3803

(57) ABSTRACT

An optical fiber connection system configured to interconnect a first and second optical fibers is described herein. The connection system comprises a pair of identical bare fiber holders (120) comprising a splice element (160) and a housing (130,140) to hold the splice element (160), wherein the splice element (160) comprises a splice body (161) having a first end and a second end and at least one alignment channel (165) having sloped channel walls (165a, b) formed in a top surface of splice body, the at least one alignment channel (165) extending from the first end to the second end of the splice body, wherein the first and second optical fibers (54) are held along four lines of contact (54a, 54b, 54a′, 54b′) when the pair of identical bare fiber holders (120) are mated together to optically connect the first and second optical fibers end to end.

### BACKGROUND

### Field of the Invention

The present invention is directed to an optical fiber connections system to interconnect a plurality of first and second plurality of optical fibers.

### Related Art

Communication network owners and operators are faced with increasing demands to deliver faster and better service to their customers. They can meet these needs for greater bandwidth by incorporating fiber optics in their networks. Optical fiber cables are used in the optical network to transmit signals between access nodes to transmit voice, video, and data information.

Some conventional optical fiber cables include optical fiber ribbons that includes a coated group of optical fibers that are arranged in a planar array. Optical fibers in the ribbon are generally disposed generally parallel to each other. Optical fiber ribbons are typically interconnected using multi-fiber optical connectors, for example, MPO/MTP connectors which can be used in data centers or other points in the network where parallel optical interconnections are needed.

Data centers rely on 10 G and 40 G transmission rates which are relatively mature technologies. The global data center Internet protocol (IP) traffic is anticipated to grow by about 31 percent annually within the next five years due to changes in the way people are using Internet. Cloud computing, mobile devices access video and social media content around the globe are driving data centers to migrate from 10 G and 40 G transmission rates to 100 G and 400 G transmission rates.

Data centers are moving toward 40 G/100 G transmission rates which utilize multiple parallel network links that are then aggregated to achieve higher overall data rates. Polarity in fiber optic cabling is essentially the matching of the transmit signal (Tx) to the receive equipment (Rx) at both ends of the fiber optic link by providing transmit-to-receive connections across the entire fiber optic system. Polarity is managed by use of transmit and receive pairs (duplex cabling), but becomes more complex with multi-fiber connectivity which support multiple duplex pairs such as MPO/MTP connectors.

Higher bandwidth links will require more power to assure signal transmission integrity. Today, heat dissipation from the electronics is already a concern and increasing the power further will amplify the issues that data centers are already facing. This increasing need for more power as well as the desire to install future flexible structured cabling systems is driving interconnection performance to low loss performance (less than 0.1 dB per connection point).

Conventional single fiber ferrule type connectors offer easy reconfiguration, but have the drawback of high optical loss (0.2-0.3 dB) and even higher loss for multi-fiber ferruled connectors such as MPO/MTO connectors (0.35-0.7 dB). Ferruled connectors must be cleaned every time that they are mated. In addition, space required for ferruled connectors limits the interconnection density.

Fusion splicing is another conventional interconnection method, which creates low loss permanent reliable splices. However, handling 250-micron fiber during preparation, fuse, storage can be troublesome. Today, such fusion splices typically require their own splice rack in the data center.

Finally, traditional gel type mechanical splices offer permanent and reliable fiber slices with insertion loss better than connectors and approaching that of fusion splices. However, these mechanical splices employ index matching gels which are not solid materials and therefore, provide no structural integrity.

Thus, need exists for new multi-fiber interconnect technology that offer “fusion-like” optical performance to facilitate datacenter bandwidth migration from 10 G and 40 G transmission rates, today, to tomorrow's 100 G and 400 G transmission rates.

### SUMMARY

According to an embodiment of the present invention, an optical fiber connection system configured to interconnect a plurality of first and second optical fibers is described herein. The connection system comprises a pair of identical bare fiber holders comprising a splice element and a housing to hold the splice element, wherein the splice element comprises a splice body having a first end and a second end and at least one alignment channel having sloped channel walls formed in a top surface of splice body, the at least one alignment channel extending from the first end to the second end of the splice body, wherein the first and second optical fibers are held along four lines of contact when the pair of identical bare fiber holders are mated together to optically connect the first and second optical fibers end to end.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIG. 1 is an isometric view of an optical fiber splice connection system according to an aspect of the invention.

FIGS. 2A-2B are two views of a bare fiber holder according to an aspect of the invention.

FIG. 3A-3B are two views of an exemplary splice element useable in the bare fiber holder of FIGS. 2A-2B.

FIG. 4 is a schematic diagram showing a plurality of optical fibers being held between two mated splice elements of the embodiment shown in FIGS. 4A-4C.

FIGS. 5A-5B are two views of a blocking element according to an aspect of the invention.

FIGS. 6A-6C are three views of an exemplary fiber organizer of the bare fiber holders according to an aspect of the invention.

FIGS. 7A-7D are four views of the second housing portion of the fiber holder shown in FIGS. 2A-2B.

FIGS. 8A-8D are four views of the mating of a pair of splice elements of the embodiment shown in FIGS. 3A-3B.

FIGS. 9A and 9B are two cross sectional views of the optical fiber splice connection system according to an aspect of the invention of FIG. 1.

FIGS. 10A-10E are five views of a second embodiment of a bare fiber holder according to an aspect of the invention.

FIGS. 11A and 11B are two views of an element holder of the bare fiber holder of FIGS. 10A-10E.

FIGS. 12A-12C are three cross-sectional views showing the mating of two identical bare fiber holder of FIGS. 10A-10E of an alternative optical fiber splice connection system according to an aspect of the invention.

FIGS. 13A-13C are three isometric views showing the mating of two identical bare fiber holder that correspond to the cross-sectional views showing the mating of two identical bare fiber holder of FIGS. 12A-12C.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention.

The exemplary optical fiber connection system described herein comprise identical bare fiber holders having identical splice elements disposed therein. The splice elements are terminated identically, then assembled into “plug” or bare fiber holder hardware that assist the mating of the two fiber arrays in an end-to end fashion. When mated, the unique design of the splice element and termination process to make identical bare fiber holders enables the optical fibers in the first fiber array to mate with the corresponding optical fiber in the second fiber array (i.e. the first optical fiber in the first array will be mated to the first fiber in the second fiber array all the way through to the twelfth fiber in the first fiber array mating with the twelfth fiber in the second fiber array). The identical bare fiber holders of the exemplary optical fiber connection system making an optical connection that is independent of polarity and gender alleviating the network design, installation and maintenance issues with managing polarity and gender of connected communication links.

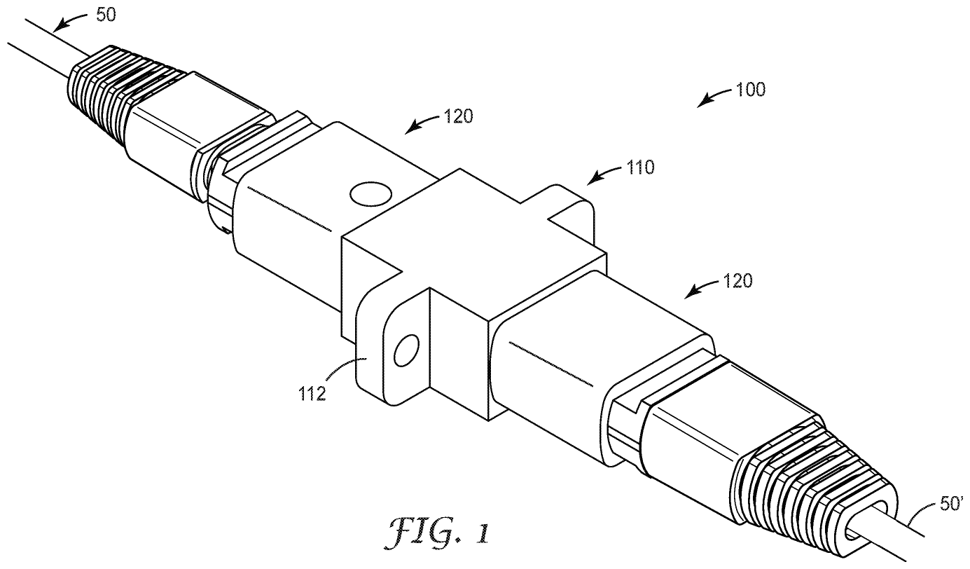

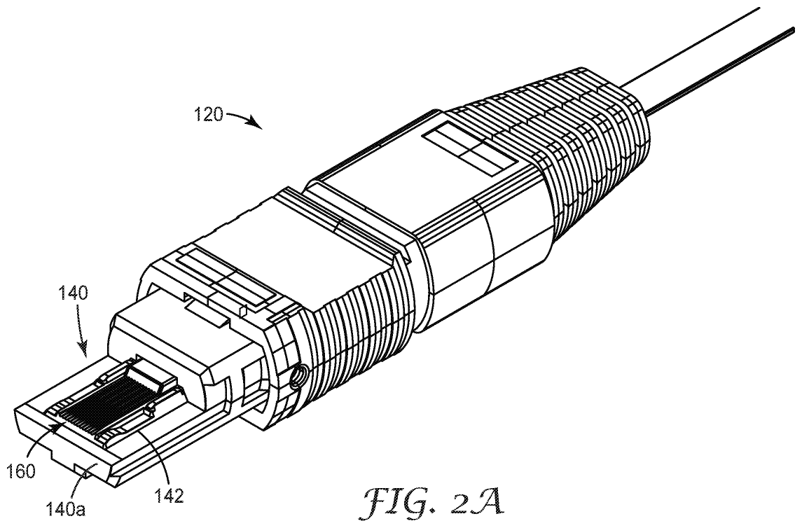

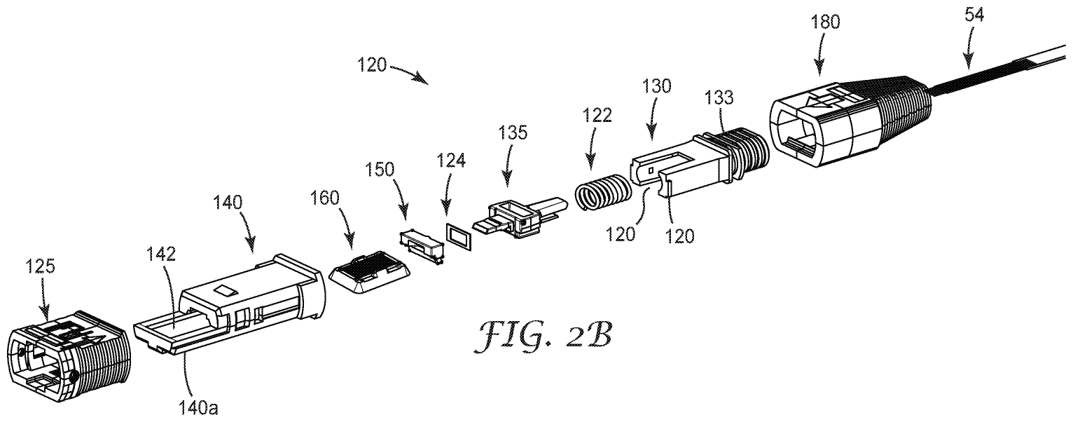

FIG. 1 shows an optical fiber splice connection system 100 that provides a ferrule-less interconnection system to optically couple a plurality of first and second optical fibers. Optical fiber splice connection system 100 comprises a pair of identical bare fiber holders, such as first and second bare fiber holders 120. First and second bare fiber holders 120 can be secured together by a clamping member 110 in the form of a clamping sleeve as shown. The clamping sleeve is a generally tubular structure having a passage way extending therethrough and a means for securing the bare fiber holders within the sleeve. The passage way is sized to secure the first and second fiber holders together when in their mated condition. In an exemplary aspect, the securing means can include a pair of latch arms (not shown) disposed on opposite sides of the passageway at each end of the sleeve. The latch arms can be configured to mate with a catch 146 disposed on a front or second housing portion 140 of each of the first and second bare fiber holders (FIG. 2A). Optionally, clamping member 110 can include a connection flange (such as flange 112) extending from the external surface of the clamping member to secure the clamping member in a bulkhead, face plate or wall of an enclosure, module, cassette or patch panel. Each of the first and second bare fiber holders 120 can comprises a release collar 125 that can be pulled away from the clamping member allowing the latch arms to be released so that the bare fiber holders may be released from the clamping member. In an alternative embodiment, the bare fiber holders may be permanently connected within the clamping member such as by and adhesive.

Bare fiber holders 120, according to the current invention, manage and protect a fiber array of one or more optical fibers having an exposed glass portion adjacent to the end face or terminal end of the optical fiber(s). In other words, the polymer coatings have been removed from at least a portion of the optical fiber(s) circumferential diameter to facilitate alignment during mating a pair of bare fiber holders to optically interconnect the fiber arrays held by said bare fiber holders.

In an exemplary aspect, optical fiber splice connection system 100 includes first and second bare fiber holders 120 that can be field terminated or installed or mounted onto an optical fiber cable or fiber ribbon in the field followed by assembly of the first and second bare fiber holders to form either a semi-permanent or permanent optical connection. Alternatively, the first and second bare fiber holders can be factory terminated or installed or mounted onto an optical fiber cable or fiber ribbon in the factory followed by assembly of the first and second bare fiber holders to form either a semi-permanent or permanent optical connection in the field.

In an exemplary aspect, the bare fiber holders can be configured to resemble the look and feel of an MPO or MTP optical fiber connector, while at the same time providing the enhance signal performance and in some embodiments permanence of an optical fiber splice.

Optical fiber splice connection system 100 is configured as a multi-fiber optical splice connection system. In the exemplary embodiments described herein, the optical fiber splice connection system is configured to connect first and second arrays of optical fibers. In the exemplary embodiment provided herein, the optical fiber splice connection system is configured to connect two 12 fiber arrays. As would be apparent to one of to ordinary skill in the art given the present description, optical fiber splice connection system 100 can be modified to include fewer optical fibers or a greater number of optical fibers in each fiber array. In one exemplary aspect, optical fiber splice connection system 100 can be modified as a single fiber optical splice connection system.

FIG. 2A shows first bare fiber holder 120 in an assembled state, and FIG. 2B shows an exploded view of the first bare fiber holder showing the bare fiber holder's internal components. The first bare fiber holder 120 has a first housing portion 130 and a second housing portion 140 that can be secured together to form the holder housing configured to arrange and hold the rest of the elements of the fiber holder. In an exemplary aspect, at least a portion of first housing portion can be inserted into a portion of the second housing portion to secure the two housing portions together.

A fiber alignment mechanism or splice element 160 is a precision element that is disposed in an element receiving pocket 142 adjacent to a first end of the second housing portion. A blocking element 150 is disposed behind splice element 160 within the internal cavity of the second housing portion which pushes on the element to ensure that it is properly positioned within the bare fiber holder. A fiber organizer 135 is disposed between the blocking element and first housing portion. The fiber organizer helps reduce the complexity of assembling the bare fiber holders onto the end of a fiber cable or fiber ribbon comprising a plurality of optical fibers.

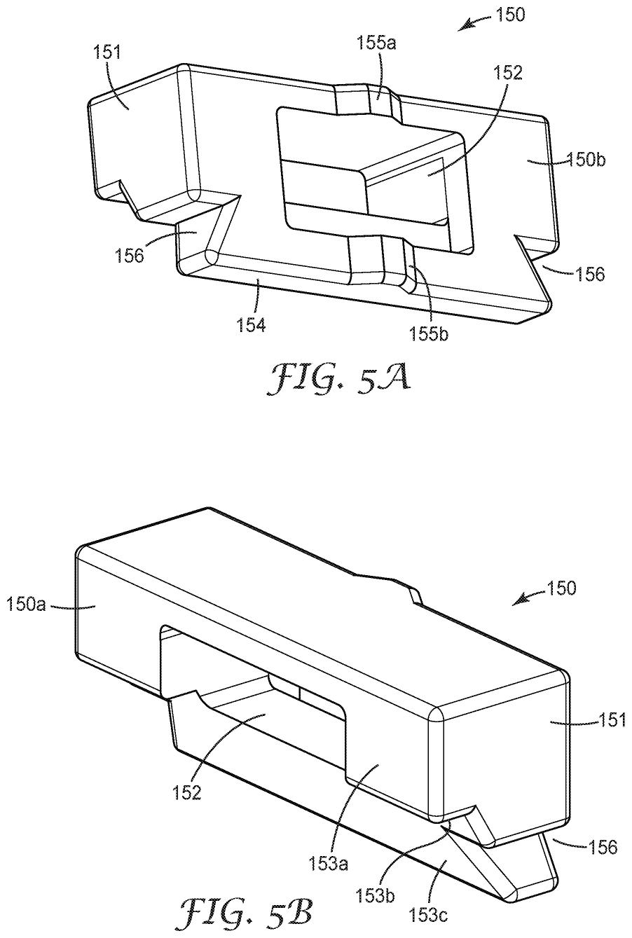

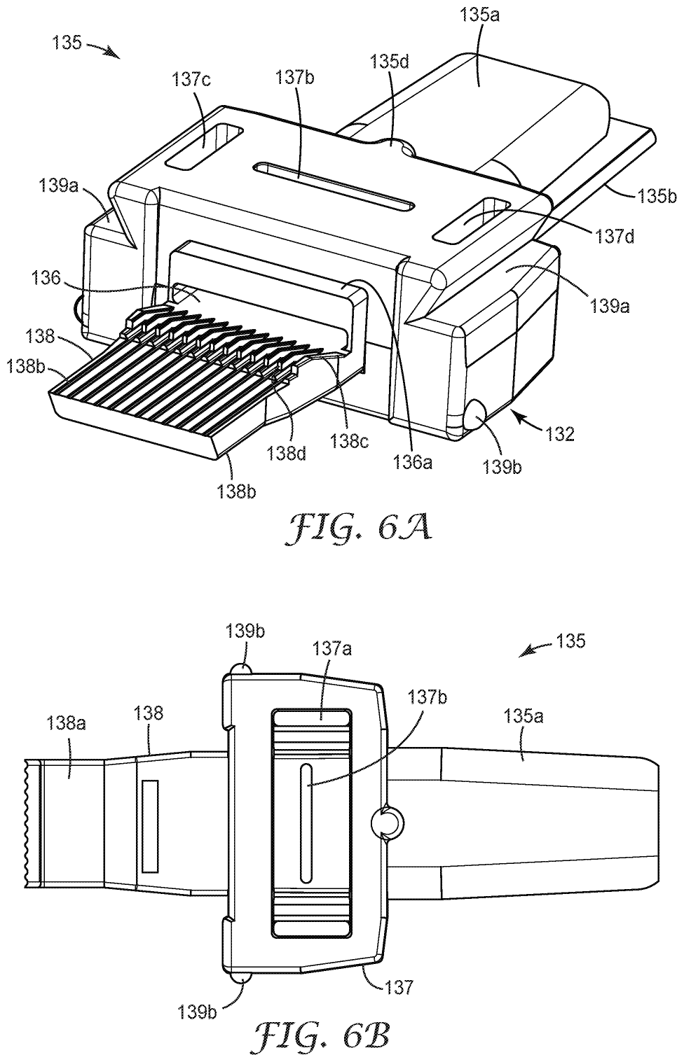

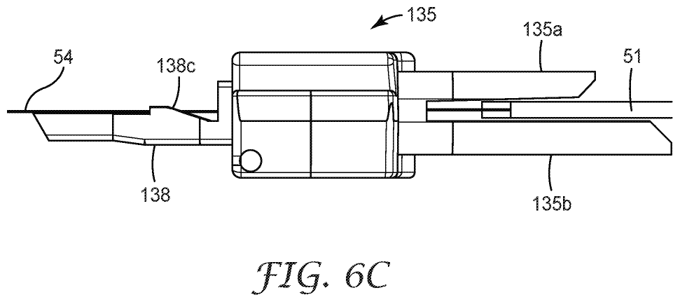

A first intermediate spring element 124 can be disposed between a front portion of the fiber organizer and the blocking element to help control the force placed on the fiber ends when they are connected. Intermediate spring 124 can be a small spring element, such as a flat or leaf spring that is seated on a shelf or shoulder portion 136a disposed around the opening of passage 136 through the body 137 of the fiber organizer 135 (see e.g., FIG. 6A). In one aspect, the intermediate spring can provide a countering force to dampen the force placed on the mated fibers. As shown in FIGS. 5A-5B, the blocking element 150 includes a pair of protrusions or bumps 155a, 155b located on a rear portion thereof that provides a point of contact with the intermediate spring and helps center the force applied by the intermediate spring element. The intermediate spring element enables a desired ratio of spring forces to be applied to the fibers being terminated and helps balance the forces within the bare fiber holder.

The actual force applied to the end of the fiber array can be controlled by tuning the compressive force of intermediate spring 124 and a compression spring 122 disposed between the fiber organizer 135 and the first housing portion 130 to create a variable resulting force on the fiber array. By using this configuration, the multi-fiber splice device(s) of the present invention can utilize the spring forces of the fiber array, the intermediate spring and the main compression spring to achieve a force balance.

In one exemplary aspect, this force balancing can be used to enable the exemplary remote grip bare fiber holders to be used to create a reliable dry splice interface (no optical coupling material or index matching gel or adhesive) in the optical path in conjunction with fiber end face shaping techniques known in the industry. For example, putting a spherical end face shape onto the fiber can eliminate the need for index matching material in the splice region and yield an insertion loss of less than 0.5 dB.

In a first embodiment, optical fiber connection system utilizes a pair of splice elements held by the first and second bare fiber holders 120. The structure of the first and second bare fiber holders can be identical.

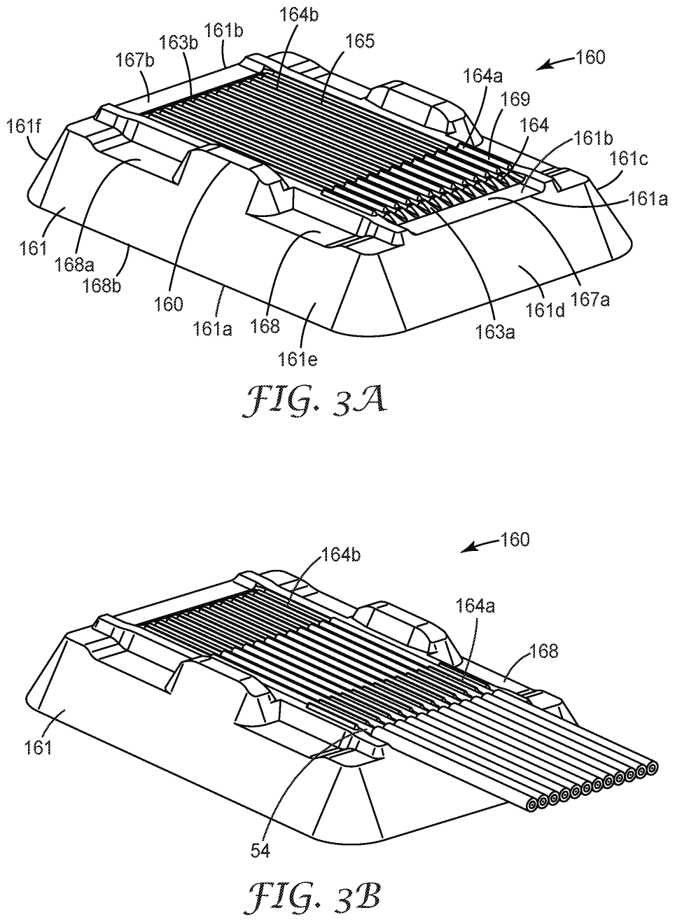

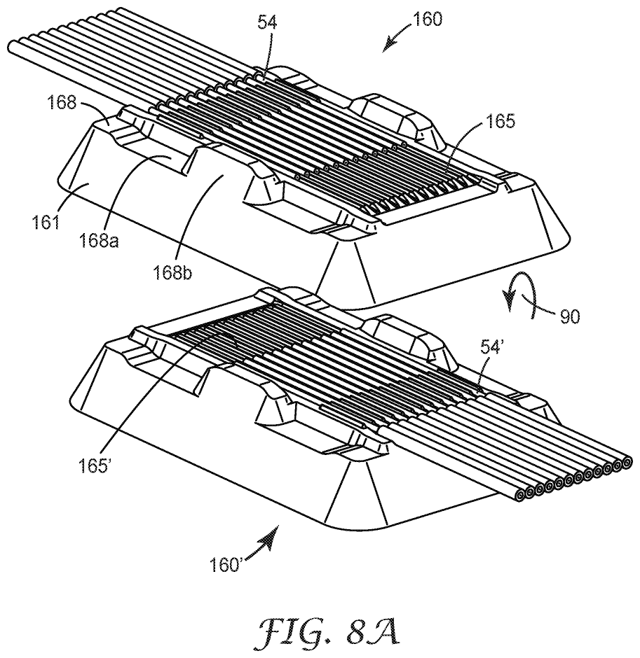

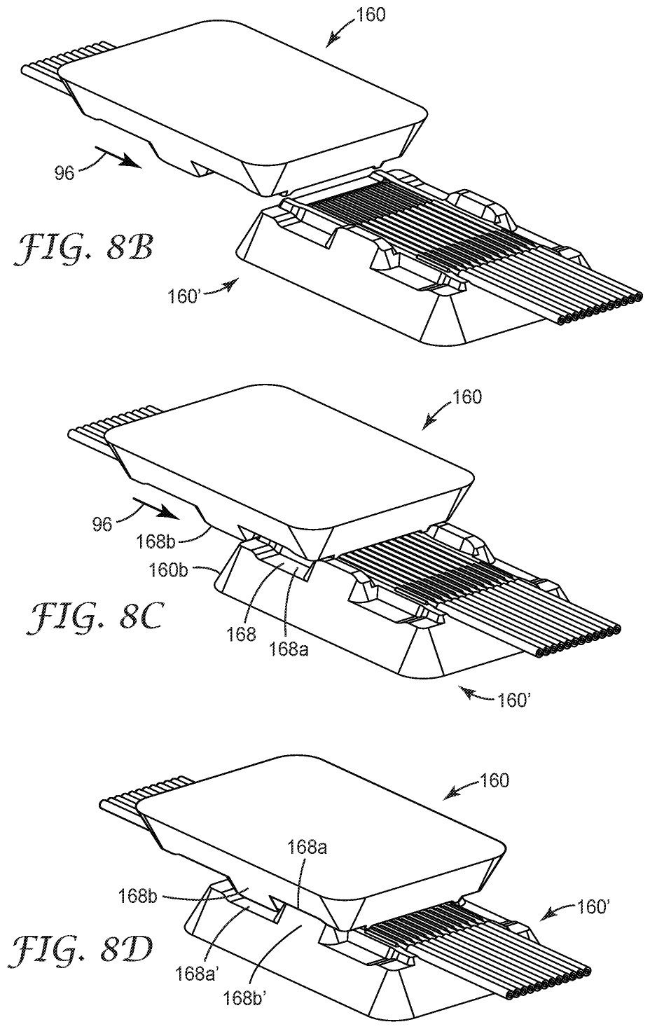

FIGS. 3A-3B show an exemplary splice element 160 that configured to join a plurality of parallel optical fibers 54 when mated with another slice element 160′ as shown in FIG. 8D. Splice elements 160, 160′ are structurally equivalent.

Splice element 160 has a generally rectangular body 161. In an exemplary aspect, the shape of the body 161 is a rectangular frustum. In alternative aspects, the body may have another shape such as a trapezoidal prism, semi-cylindrical solid, bisected prism or other three-dimensional shape having at least one generally flat major surface. The body 161 has a bottom surface 161a, a smaller top surface 161b and four sloped side walls 161c-161f extending from the bottom surface to the top surface. In an exemplary aspect, the side walls are sloped at an angle between 45° and about 85°, preferably at an angle of about 60° relative to the bottom surface.

Splice element 160 has an integral alignment and clamping mechanism in the form of a plurality of alignment channels 165, formed in the top surface 161b of body 161 between first and second fiber landing areas 167a, 167b disposed adjacent to the first end 161a and the second end 161b of the splice body, respectively. Each alignment channel is configured to guide and support a single optical fiber. In the exemplary embodiment shown in FIG. 3A, the splice element has 12 parallel alignment channels. In alternative embodiments, the exemplary optical fiber slice element can have fewer or more alignment channels depending on the final application and the number of optical fibers to be spliced. Thus, in some embodiments, the splice element can have a single alignment channel for joining a pair of simplex optical fiber cables. In other embodiments, the exemplary splice element can have a larger number of alignment channels.

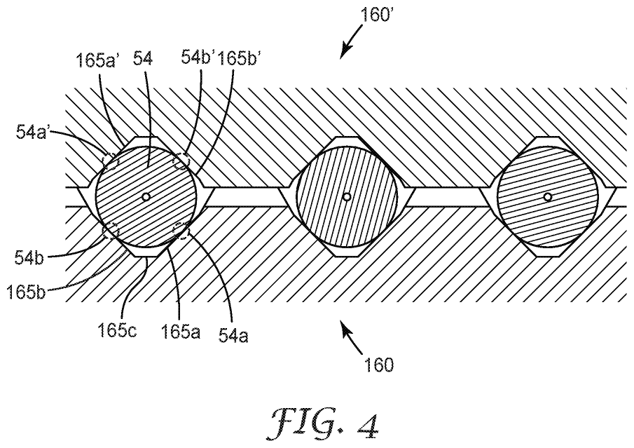

Alignment channels 165 can be substantially flat or planar as they extend first and second fiber landing areas 167a, 167b of the splice element 160. In the exemplary embodiment shown in FIGS. 3A-3B, the alignment channels are continuous structures extending from the first entrance opening 163a near the first end 161a of splice body 161 to the second entrance opening 163b near the second end 161b of splice body 161. The alignment channels can have a characteristic cross-section, such as the trapezoidal profile shown in FIG. 4. Alternatively, alignment channels can have a semi-circular cross section, a rectangular cross section, a v-shaped cross section.

The optical fibers can be inserted into the alignment mechanism through entrance openings 163a and 163b. In some aspects, the entrance openings 163a, 163b can comprise a funneling inlet portion formed by the tapering of the partitions 164 between adjacent channels to provide for more straightforward fiber insertion. In other embodiments, the entrance apertures can be fully or partially cone or funnel-shaped to guide the insertion of the optical fibers into the alignment channels 165.

The alignment channels can have a comb structure 169 adjacent to at least one of the first and second entrance openings to facilitate the insertion of the optical fibers into the alignment channels 165. In the comb structure, a portion 164a of partitions or walls 164 between adjacent alignment channels are higher and tapered than the remaining section 164b of partitions 164.

The entrance openings 163a, 163b are characterized by a interchannel pitch (i.e. the distance between the centerline of adjacent alignment channels). In the embodiment, shown in FIGS. 3A and 3B, the channel pitch at the first end of the splice element is the same as the channel pitch at the second end of the splice element. In this exemplary embodiment, the interchannel pitch is approximately the same as the inter-fiber spacing in a conventional 12 fiber ribbon. In an alternative embodiment, the interchannel pitch at the first end of the splice element and the channel pitch at the second end of the splice element can be different. For example, the channel pitch at the first end of the splice element can be set to the fiber spacing of a conventional optical fiber ribbon, while the channel pitch at the second end of the splice element can be at a different value such as when splicing individual optical fibers or when splicing two or more smaller optical fiber ribbon ribbons or optical fiber modules to a larger ribbon fiber.

Alignment channels 165 are configured such that a fiber disposed in the alignment channel will contact each of the sloped channel walls 165a, 165b of the alignment channel along a line of contact 54a, 54b disappearing into the page in FIG. 4 along the length of the fiber disposed within the alignment channel. Thus, when two splice elements 160, 160′ are brought together, each optical fiber will have four lines of contact 54a, 54b, 54a′ 54b′ with the splice elements to reliably position and hold said optical fibers. In an exemplary aspect, the four lines of contact can be spaced relatively uniformly around the optical fiber.

The sloped channel walls of the alignment channels can be disposed at an angle relative to the bottom wall 165c of the alignment channel of between 38° and about 60°, preferably at an angle of about 45° relative to the bottom surface in the embodiment shown in FIG. 4. The alignment channels can be characterized by a characteristic alignment channel width, w, between the lines of contact extending longitudinally along the sloped channel walls of the alignment channel where the optical fibers contact the alignment channel. In an exemplary aspect, the alignment channel width can be between about 85 microns and about 120 microns, preferably between about 95 microns and about 110 microns.

Fiber organizer 135, shown in FIGS. 6A-6C, is a multi-purpose element that provides for orderly insertion of the plurality of optical fibers into the alignment mechanisms in the first and second bare fiber holders. The fiber organizer has a body portion 137 having a passage 136 extending therethrough to permit insertion of a plurality of optical fibers through the body of the fiber organizer. The body of the fiber organizer supports securing the plurality of optical fibers in a remote gripping region or pocket 137a (FIG. 6B) of the fiber organizer so that the plurality of optical fibers can be firmly held in bare fiber holder 120. In this way, the fibers do not need to be attached to the alignment mechanism (i.e. splice elements 160 in the first and second bare fiber holders 120, 120′, shown in FIG. 2A), so that the optical fibers are free to move or bow within the alignment mechanism. A smaller slot or opening 137b can be formed opposite pocket 136a. Additional slots and openings (such as slots 137c, 137d) can also be provided in the fiber organizer to accommodate features of the clamping mechanism, if needed. In one aspect, a mechanical clamp (not shown) can be utilized to secure an array of optical fibers within the fiber organizer. Alternatively, an adhesive, such as a fast-curing UV or visible light initiated adhesive or a thermally activated adhesive, such as a hot-melt material can be utilized to secure an array of optical fibers within the fiber organize.

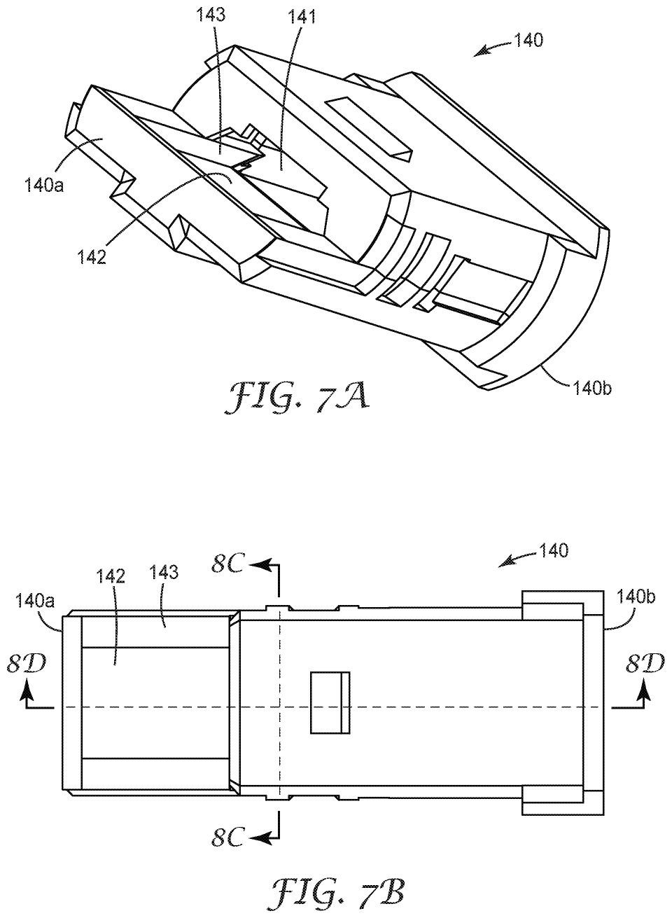

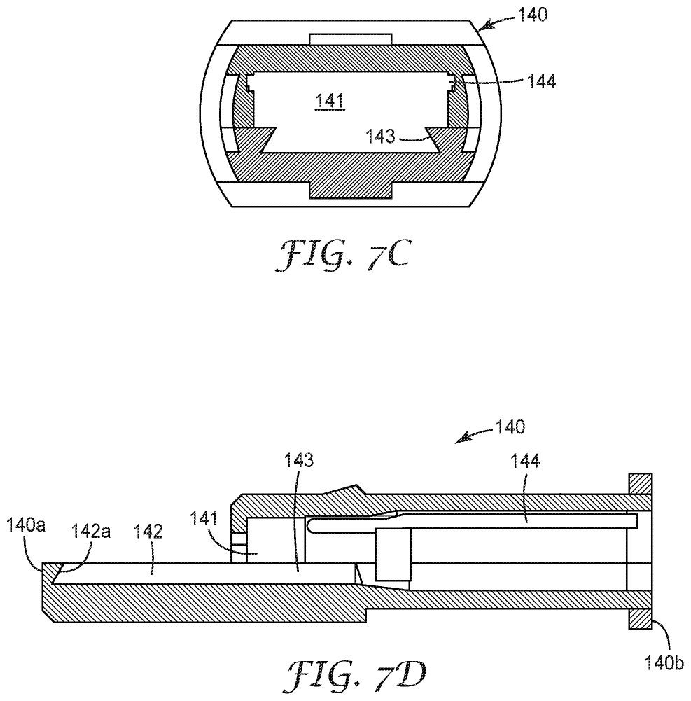

Fiber organizer 135 includes a fiber comb portion 138 that is used to support, align and guide the optical fibers to be terminated. The fiber comb portion includes a top surface 138a (see FIG. 7B) and an array of grooves 138b, located on the underside of the top surface, disposed on an end of the fiber organizer (nearest the splice element when assembled), with each individual groove or channel 138b configured to guide and support a single optical fiber. The fiber comb portion also includes a ramp section 138c adjacent groove array 138b and disposed between the groove array and the body portion 137 of the fiber organizer. The ramp section includes gradual rising dividing structures 138d that separate the individual groove which can help align the individual fibers during the fiber insertion process. The structure of the fiber comb portion can separate potentially tangled fibers, and arrange the fiber array in a uniform pitch, and allowing for straightforward feeding of the fiber array into the alignment channels of the alignment mechanism. In addition, the groove array/ramp structure of the fiber comb portion allows for precision placement of the fiber array with the naked eye.

Fiber organizer 135 also includes a rear portion having an opening (not shown) that allows for insertion of the optical fibers into the fiber organizer passage 136. In one aspect, the rear portion includes extending support structures 135a and 135b (disposed opposite each other about the opening) that are configured to receive and support compression spring 122. The compression spring can fit over the support structure such that it rests against a rear of the body portion 137 of the fiber organizer on one side of the compression spring and against the first housing portion on the opposite side of the compression spring. A contact bump or protrusion 135d can be formed on the rear portion of the fiber organizer to contact compression spring 122 and to center the force of the spring relative to the fiber organizer. Thus, when first fiber holder 120 is assembled, the resilient element/compression spring 122 will be disposed between the fiber organizer 135 and the first housing portion 130.

In an exemplary aspect, fiber organized 135 can include a guide pin or protrusion 139b extending from the sides of the fiber organizer to facilitate proper positioning of the fiber organizer in the second housing portion of the exemplary bare fiber holder. The guide pins fit into guide slots 144 formed in the interior side walls of the second housing portion 140 as illustrated in FIGS. 8C and 8D.

In addition, the fiber organizer 135 may have one or more <-shaped notches 139a formed in the sides thereof that can be further used to guide and position the fiber organizer within the second housing portion 140. The <-shaped notches 139a can be guided on inclined side walls 143 which help form the element receiving pocket 142 to ensure proper positioning of the fiber organizer within the second housing portion of the first and second bare fiber holders.

According to an aspect of the present invention, fiber organizer 135 can be formed or molded from a polymer material, although metal and other suitable materials can also be utilized. For example, fiber organizer 135 can comprise an injection-molded, integral material. The choice of suitable materials for the fiber organizers can be made in accordance with the temperature stability parameters.

In an exemplary aspect, the spice elements 160 of the present invention can be formed using a sol casting resin to generate net shape silica ceramic parts, such as is disclosed in U.S. Provisional Patent Application Nos. 62/382,944 and 62/394,547, herein incorporated by reference in its entirety.

Referring again to FIGS. 3A and 3B and FIGS. 8A-8D, splice element 160 includes a rail 168 disposed along each longitudinal edge of splice body 161. Splice element 160 can include standoff features that provide a controlled vertical offset between two splice elements 160, 160′ during at least a portion of the mating process. For example, a first plurality of optical fibers can be disposed in the alignment channels 165 in first splice element 160 and a plurality of second optical fibers 54′ can be secured in the alignment channels 165′ in a second splice element 160′ (directional arrow 90 in FIG. 8A represents the inversion or flipping over of the first spice element in preparation to mate the first and second splice elements 160, 160′). The optical connection is made by sliding the splice elements on the standoff features formed on the first and second splice elements until the standoff features fit into depressions formed in the rail surface of the other of splice elements. Each rail of the first and second splice elements can include a locking depression 168a and/or stand-off feature in the form of a locking protrusion 168b. For example, splice element 160 includes a locking depression 168a and a locking protrusion 168b in each rail 168.

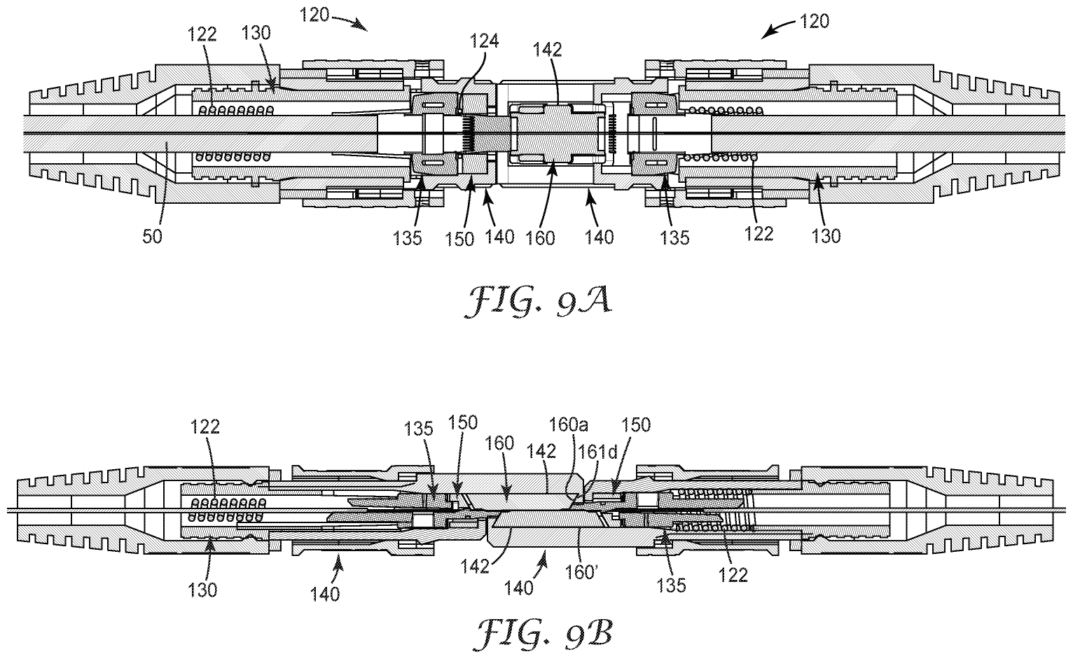

FIGS. 9A and 6B are two orthogonal cross section views of exemplary optical fiber connection system 100 showing how the internal component are arranged in the bare fiber holder housing. Splice element 160 disposed in the element receiving pocket 142 with the first end 160a disposed adjacent to the first end of the second housing portion with the inclined sidewall 161d of the splice element disposed against the incline front wall 142a of the element receiving pocket.

Referring to FIGS. 5A-5B and 9, blocking element 150 is the next component that is inserted into the second housing portion 140 as shown in FIG. 9B. Blocking element 150 anchors the splice element 160 in the element receiving pocket by forming the fourth wall of the receiving pocket. Blocking element 150 includes a front side 150a, a back side 150b and an opening 152, to permit passage of a portion of the comb structure of the fiber organizer which is holding the optical fibers to be spliced by the connection system of the present invention. The front side of the blocking element includes a vertical wall portion 153a, a cutaway portion 153b and an angled wall portion 153c. The angled wall portion 153c is configured to push against inclined wall 161f of splice element 160 to ensure that it is pushed fully into the element receiving pocket 142 as shown in FIG. 9B. The cutaway portion will rest against the top surface of the splice to control the vertical position of the splice element in the element receiving pocket. In an exemplary aspect, blocking element 150 can include alignment slots 156 along either side 151 of the blocking element that are configured to engage with inclined sidewalls 143 of the element receiving pocket. The back side of the blocking element is a generally vertical surface that includes a pair of protrusions or bumps 155a, 155b located on a rear portion thereof that provides a point of contact with the intermediate spring and helps center the force applied by the intermediate spring element 124.

FIGS. 8A-8D illustrate the mating sequence for a pair of splice elements 160, 160′ to optically connect a first and a second plurality of optical fibers 54, 54′. The superstructure around the splice elements is not shown in the figures so that the interactions of the splice elements can be clearly seen. FIG. 8A is a top isometric view of the two splice elements. The first splice element is flipped over or inverted as provided by directional arrow 90. FIG. 8B shows splice elements 160, 160′ moving toward each other in a forward and slightly downward direction as provided by directional arrow 95. FIG. 8C shows the splice elements at the point where the locking protrusion 168b of splice element 160 contacts rail 168′ at the second end 160b′ of splice element 160. Splice element 160 slides along on the surface of the locking protrusion as indicted by directional arrows 96. Splice element 160 continues to slide forward until the locking protrusion is seated in locking depression 168a′ of splice element 160′ as shown in FIG. 8D.

The rails of the splice element provide course element-to-element alignment to bring the elements together in a controlled manner while the alignment channels in the splice elements provide the fine fiber-to-fiber alignment necessary to make a robust optical connection.

Provided that the second housing portion is made of a transparent or semi-transparent material, it may be desirable to permanently secure, the first and second bare fiber holders 120 can be permanently secured together with an optical adhesive such as the optical adhesive described in U.S. patent application Ser. No. 15/696,901. Alternatively, the first and second bare fiber holders can be semi-permanently secured together via a mechanical clamping element, such as clamping element 110, in either a dry state or using an index patching material disposed between the terminal ends of the optical fiber arrays being joined in the exemplary an optical fiber splice connection system 100 exemplified by FIGS. 1-9 as provided above.

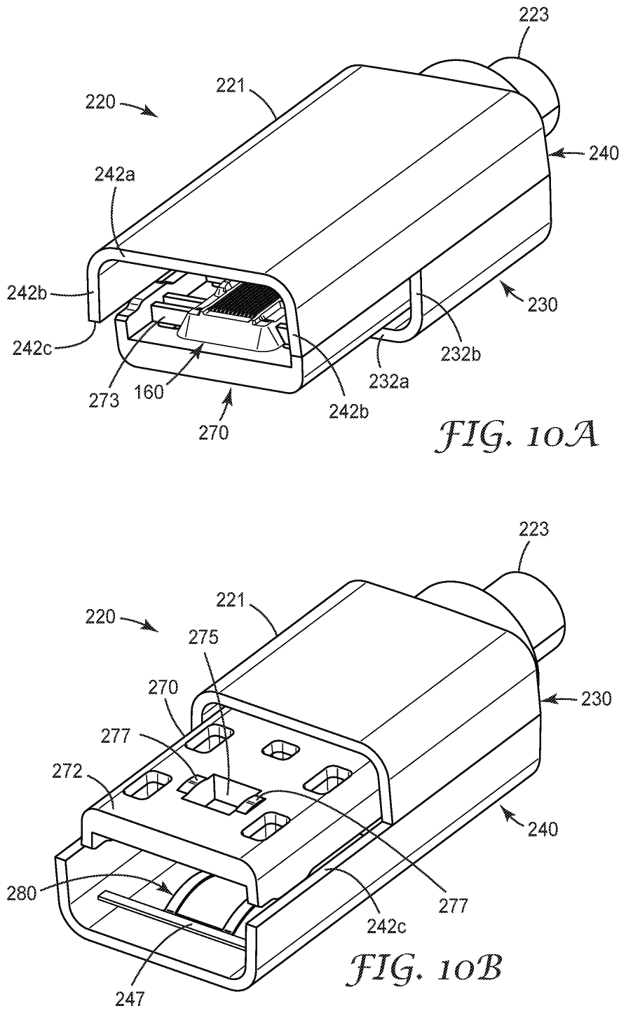

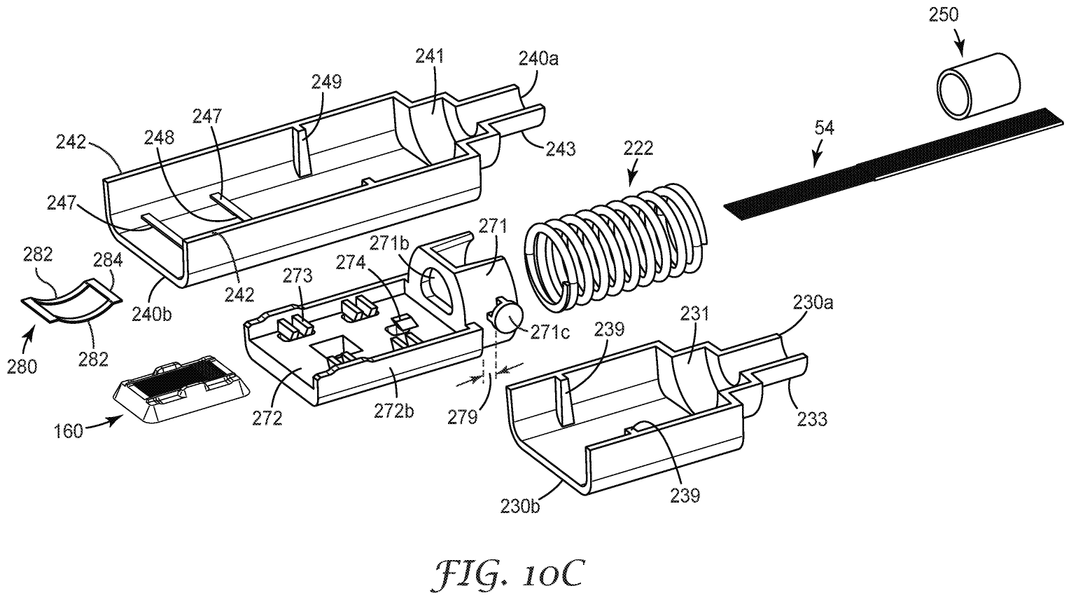

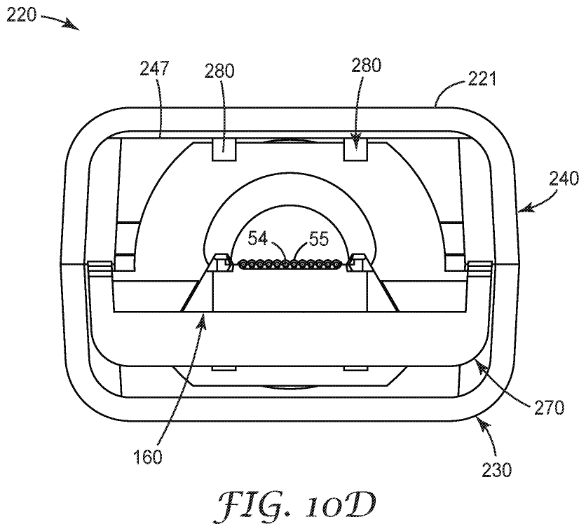

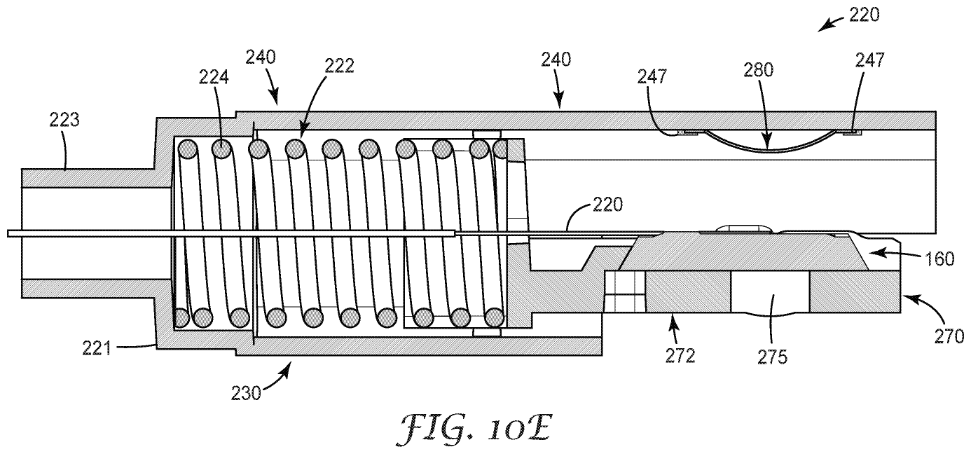

A second embodiment of an exemplary optical fiber connection system is shown in FIGS. 10A-10E through 13A-13C. Optical fiber splice connection system 200 provides a ferrule-less interconnection system to optically couple a plurality of first and second optical fibers. Optical fiber splice connection system 200 comprises a pair of identical bare fiber holders, such as first and second bare fiber holders 220. In one aspect, the bare fiber holders may be secured together with an auxiliary clamping member (not shown) or by an adhesive. The first and second bare fiber holders 220 that can be field terminated, installed or mounted onto an optical fiber cable or fiber ribbon in the field followed by assembly of the first and second bare fiber holders to form either a semi-permanent or permanent optical connection. Alternatively, the first and second bare fiber holders can be factory terminated, installed or mounted onto an optical fiber cable or fiber ribbon in the factory followed by assembly of the first and second bare fiber holders to form either a semi-permanent or permanent optical connection in the field.

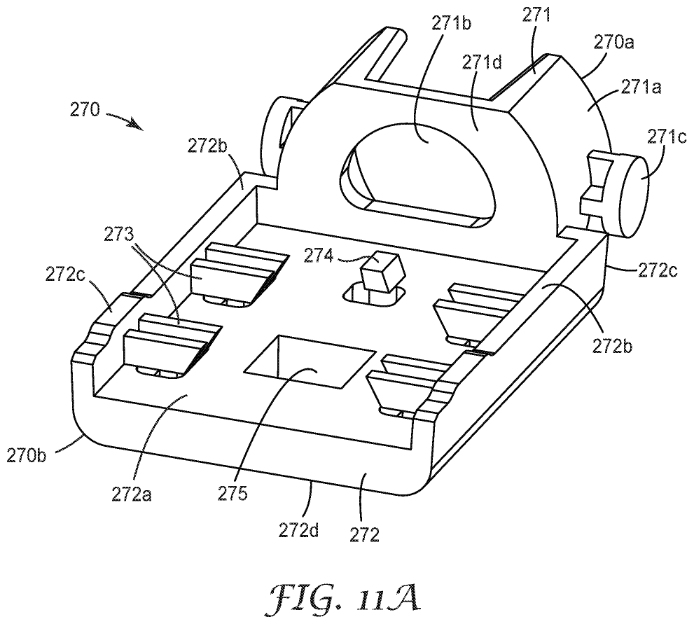

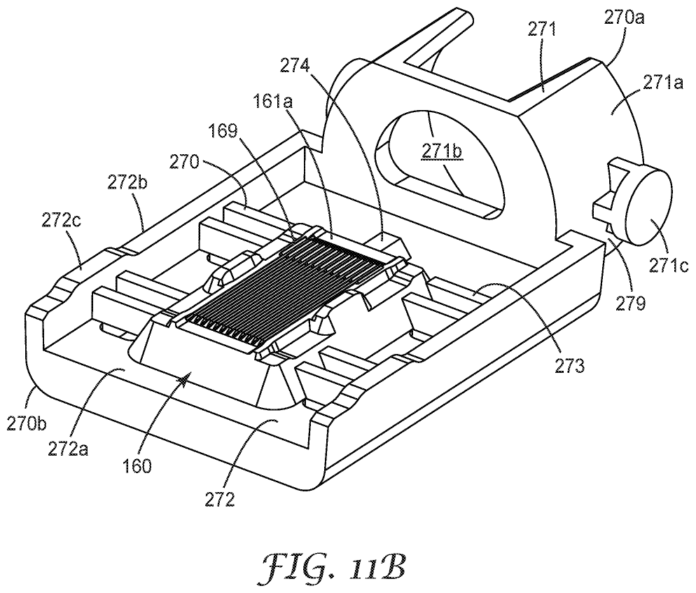

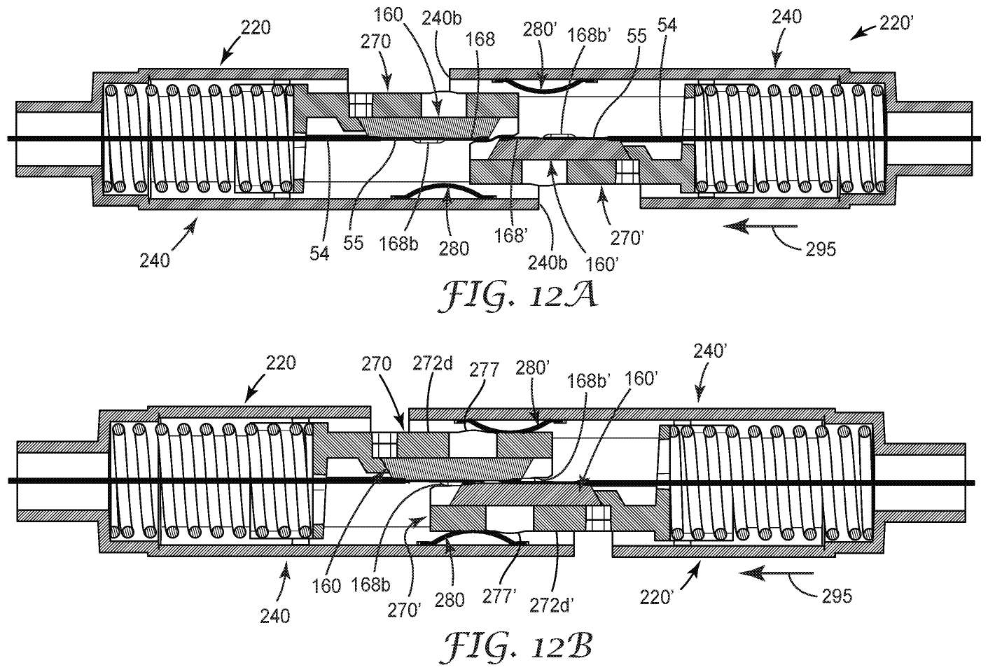

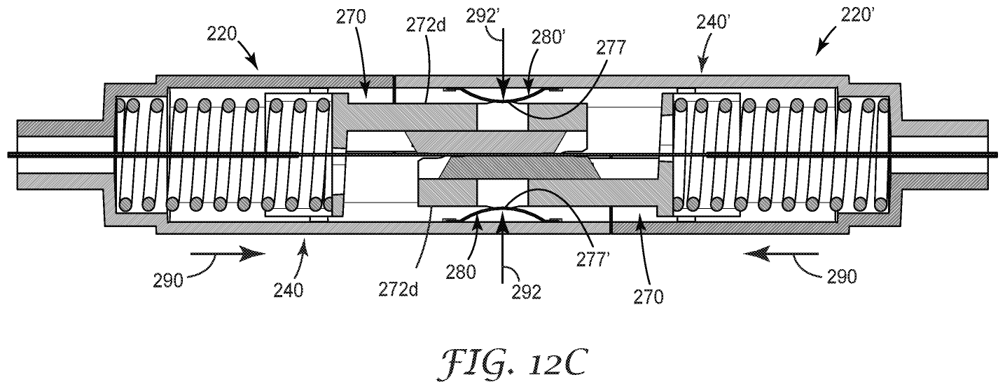

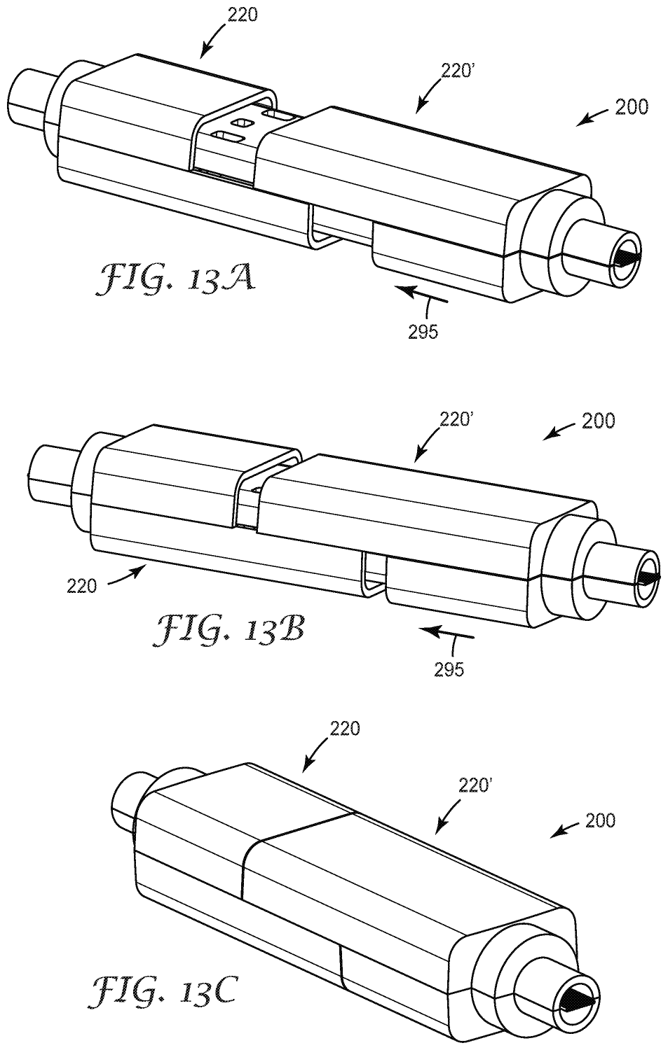

FIGS. 10A-10E illustrated the features and components of bare fiber holder 220. FIGS. 11A and 11B are detail views of the element platform 270 of bare fiber holder 220. FIGS. 12A-12C are three cross-sectional views showing the mating of two identical bare fiber holder 220 of an alternative optical fiber splice connection system 200 according to an aspect of the invention, and FIGS. 13A-13C are three isometric views showing the mating of two identical bare fiber holder that correspond to the cross-sectional views showing the mating of two identical bare fiber holder of FIGS. 12A-12C.

Bare fiber holder 220 has a first or lower housing portion 230 and a second or upper housing portion 240 that can be secured together to form the holder housing 221. Holder housing 221 is configured to arrange and hold the remaining components of the bare fiber holder and to protect the exposed bare glass portion 55 of the optical fibers 54 supported within the bare fiber holders. A crimp ring (not shown) can secure the first and second housing portions together. Optionally, additional latching features (not shown) can be added to further secure the first and second housings. Alternatively, the first and second housing portions can be adhesively bonded together, secured by a snap fit, or a latching system. In alternative embodiment, the holder housing can have a clam shell configuration having a first housing portion and a second housing portion that are joined by a living hinge. In the exemplary embodiment shown in FIGS. 10A-10E, each of the first and second housing 230, 240 can include a semi-cylindrical anchoring portion 233, 243 formed at their first ends 230a, 240a, respectively. The semi-cylindrical anchoring portion 233, 243 form a cylindrical anchoring portion 223 when the first and second housing portions are assembled to for the holder housing 201. The crimp ring can be fitted over and secured to the cylindrical anchoring portion 223 to anchor the cable jacket or strength members an optical fiber cable to the bare fiber holder to enhance the cable retention strength in the bare fiber holder. In the exemplary aspect shown in FIG. 10A, the cylindrical anchoring portion has a smooth outer surface. In some embodiments, it can be desirable to add teeth or ribs to the outer surface of the cylindrical anchoring portion to further increase the retention force.

In an exemplary aspect, the first and second housing portions 230, 240 can have a generally open rectangular channel profile having a base 242a and a pair of parallel walls 242b extending from the base, the side walls having a top edge 242c extending along the length of the side walls. The top edge 232c of the first housing portion 230 is joined to a portion of the top edge 242c of the second housing portion 240 when the first and second housing portions are assembled to for the holder housing 201.

Optionally, a strain relief boot (not shown) can be mounted over the crimp ring to provide strain relief and bend control to an optical fibers or optical fiber cable at the point where the optical fibers enter the holder housing of the bare fiber holder.

Referring to FIGS. 10C, 10E and 12B, a leaf spring 280 can be attached to second housing portion 240 of bare fiber holder 220 to provide a vertical mating force (represented by directional arrows 292 in FIG. 12C) on a bottom surface 272d′ of element platform 270′ of a mating bare fiber holder 220′. Similarly, leaf spring 280′ attached to second housing portion 240′ of bare fiber holder 220′ provides a vertical mating force (represented by directional arrows 292′ in FIG. 12B) on a bottom surface 272d of element platform 270 of a mating bare fiber holder 220. The combination of the vertical mating forces 292, 292′ ensures the vertical alignment of the ends of the first and second optical fibers, while the sloped walls of the alignment channels in the splice elements 160, 160′ provide the lateral alignment of the optical fibers.

In an exemplary aspect, the second housing 240 can include a pair of spaced apart to anchor bars 247 formed on the interior surface 241 of the second housing portion. Leaf spring 280 can be fitted into a slot 248 formed in the anchor bars to secure the leaf spring to the second housing portion. The leaf spring can have a generally arched profile comprising two arched arms 282 connected at both ends by a flat footer portion 184. The footer portion fits into the slot formed in the anchor bars to secure the leaf spring to the second housing portion. In an exemplary aspect, the leaf spring can be stamped from a piece of spring steel and formed into the leaf spring as shown in FIG. 10C.

Bare fiber holder 220 further comprises a fiber alignment mechanism or splice element 160 that is held by an element platform 270. In the exemplary aspect shown in FIGS. 10A, 10C and 11B, splice element 160 is the same splice element used in bare fiber holder 120, although the bare fiber holder and element platform can be used with different splice element designs. In this embodiment, the optical fibers can be secured directly to splice element 160 using an adhesive. For example, an adhesive such as a fast-curing UV or visible light initiated adhesive or a thermally activated adhesive, such as a hot-melt material can be utilized to secure an array of optical fibers within the comb structure 169 and/or landing area 161a of the splice element. Securing the optical fibers in this area of the splice element still provides the advantages of remote gripping the optical fibers, but without the need for a separate fiber organizer such as that provided in bare fiber holders 120, described above in reference to FIGS. 2A-2C.

Element platform 270 includes a collar portion 271 which is attached to an element stage 272. Collar portion 271 can have a generally cylindrical shape that is configured to receive a portion of a compression spring 224. As shown in FIG. 11A, the collar portion can have an opening 271b through an end wall portion 271d where the element stage attaches to the collar portion. The opening permits passage of the optical fibers through the end wall of the collar portion element platform.

Element stage 272 has a base and sidewalls 272b extending from the base. The side walls extend along the longitudinal edges of the base from a second end 270b of the element platform to the collar portion 271. The base has a top surface 272a and a bottom surface 272d. Splice element 160 is anchored to the top surface by element catches 273, 274. In an exemplary aspect, the sidewalls can include a protrusion or bump 272c formed on the top of the sidewalls 272b to control the vertical offset between the splice elements held on the element platform during the mating of a pair of bare fiber holders 220.

In an exemplary aspect, element stage 272 can include a window 275 that extends through the base of the element stage under the interconnection area on the splice element 160 where the first and second optical fibers are joined end-to-end (see FIG. 10E). In an exemplary aspect, a pair of bare fiber holders 220 can be permanently joined together by an index matched optical adhesive. An exemplary optical adhesive can be cured with actinic radiation via a rapid and straightforward procedure using an eye-safe visible, e.g., blue, LED light source such as is described in U.S. patent application Ser. No. 15/695,842, herein incorporated by reference in its entirety. The curing radiation can be shined on the adhesive through at least one of the exemplary splice elements through window 275.

Collar portion 271 can also include a pall 271c that extends from the outer surface 271a of the collar portion either side of the collar portion. A translation gap 279 is formed between the pall and the end 272c of the sidewall 272b. Tapered ridges 239, 249 disposed on the interior surface of the first and second housing portions 230, 240 form a track that fits in gap 278 to control the relative position of the element platform when two of the exemplary bare fiber holders 220 are mated together.

The element platform 270 can be resiliently mounted in the holder housing 221. In an exemplary aspect, a compression spring 222 can be disposed between the holder housing 201 and the element platform that applies a forward force (represented by directional arrows 290 in FIG. 12C) on the element platform and the splice element disposed thereon. For example, the holder housing can comprise a spring seating area 224 that is forms when the first and second housing portions 230, 240 are assembled together.

Using this configuration, optical fiber connection system 200 can utilize the spring forces of the fiber array, and the main compression spring to achieve a force balance to create a reliable dry splice interface (no optical coupling material or index matching gel or adhesive) in the optical path in conjunction with fiber end face shaping techniques known in the industry.

FIGS. 12A-12C are three cross-sectional views showing the mating of two identical bare fiber holders 220, 220′ of optical fiber splice connection system 200, and FIGS. 13A-13C are three isometric views showing the mating of two identical bare fiber holders that correspond to the cross-sectional views of FIGS. 12A-12C.

FIGS. 12A and 13A illustrate the bare fiber holders 220, 220′ at the beginning of the mating process. The bare fiber holders 220, 200′ are brought together until the top edge 242c, 242c′ at the second ends 240b, 240b′ of the second housing 240, 240′ contact each other. As bare fiber holder 220′ moves toward bare fiber holder 220, as indicated by directional arrow 295 element stage 272′ of bare fiber holder 220′ enters the space between stage element stage 272 of bare fiber holder 220 and the second housing 240. Similarly, the element stage 272 of bare fiber holder 220 enters the space between stage element stage 272′ of bare fiber holder 220′ and the second housing 240′ at the same time.

As bare fiber holder 220′ continues to move toward bare fiber holder 220, the cam surface of the locking protrusions 168b, 168b′ and the rails 168′, 168 engage to roughly align the height of the splice elements 160, 160′ with respect to one another. FIGS. 12B and 13B shows the initial engagement between the rails (not shown) and the locking protrusions 168b, 168b′. As this occurs, leaf spring 280, 280′ begins to apply a vertical force to the back surface 272d, 272d of the element stages 272 pushing splice elements 160, 160′ toward each other. The vertical force increases as the leaf spring contact the camming feature 277 (best seen in FIG. 10) on the bottom surface of the element stage, up to 3.5-4.5 lbs. Once the bare fiber holders 220, 220′ are fully mated as shown in FIGS. 12C and 13C, the leaf springs 280, 280′ continues to apply the vertical force to element holders 270′, 270 and in turn the splice elements 160′160. The vertical force is centered on the point where the first and second optical fibers 54, 54′ meet to secure and align the fibers in the alignment channels of the splice elements.

In a first embodiment, bare fiber holders can be mated as a dry splice (i.e. no optical coupling material present between the end faces of the first and second optical fibers between the first and second optical fibers. In an alternative embodiment, an optical coupling material, index matching gel or index matched adhesive can be used in the optical path.

An exemplary connection made in accordance with the present disclosure should have an insertion loss of less than 0.1 dB, a return loss variation of less than 5 dB when temperature cycled from −10° C. to +75° C. and have a pullout strength of greater than 0.45 lbf.

The exemplary optical fiber connection system can be used in a wide range of applications where low loss optical connections are needed, especially when the connections are semi-permanent or permanent. In some embodiments, the exemplary multifiber devices can be used in fiber optic cassettes, terminals, patch panels, etc. where the splice can be located at a bulkhead or through the wall of an enclosure.

For example, the exemplary connection system can be used in an optical cassette, such as is described in U.S. Provisional Patent Application No. 62/544,370, herein incorporated by reference, wherein the optical cassette or terminal comprises an enclosure having a top, a bottom and a plurality of side walls disposed between the top and the bottom, and at least one exemplary connection system of the present disclosure disposed through one of the plurality of sidewalls. A plurality signal paths can exit the cassette or through one of the plurality of sidewalls wherein the plurality signal paths can comprise a connection point at the sidewall where the plurality signal paths exit the cassette. The exemplary optical fiber connection system of the present disclosure can be used for the multifiber connection device and/or for the single fiber connection points. In an exemplary use in which the cassette or terminal can comprise a plurality of paired single fiber connection points, such that the first of the pair of single fiber connection points is designated as a transmit port and the second of the pair of single fiber connection points is designated as a receive port. In this aspect, signals carried by the plurality of outside optical fibers can be reordered within the cassette or terminal such that the signals leaving the cassette are in a different order than they enter the cassette. In some embodiments, this reordering of the signal paths is used to manage the polarity of the send and receive ports.

In an alternative application, the exemplary optical fiber connection system can be used to make an optical fiber harness assembly. For example, in the exemplary optical fiber connection system may be used to directly connect fiber fanout to a continuous transmission portion or cable in either the field or in the factory. This can be especially advantageous when the fanout portion is made in a first location, the transmission portion is made at a second location and where the fanout portion to a continuous transmission portion are brought together at a third location.

Various modifications, equivalent processes, as well as numerous structures to which the present invention may be applicable will be readily apparent to those of skill in the art to which the present invention is directed upon review of the present specification.

1. An optical fiber connection system configured to interconnect first and second optical fibers, the connection system comprising:
first and second identical bare fiber holders each comprising a splice element and a housing to hold the splice element,
wherein the splice element comprises a splice body having a first end and a second end and at least one alignment channel having sloped channel walls formed in a top surface of splice body, the at least one alignment channel extending from the first end to the second end of the splice body, wherein the first and second optical fibers are held along four lines of contact when the pair of identical bare fiber holders are mated together to optically connect the first and second optical fibers end to end.

2. The connection system of claim 1, wherein first and second lines of contact are where the first and second optical fibers contact the sloped channel walls of the at least one alignment channel of the splice element of a first of the pair of identical bare fiber holders and third and fourth lines of contact are where the first and second optical fibers contact the sloped channel walls of the at least one alignment channel of the splice element of a second of the pair of identical bare fiber holders.

3. The connection system of claim 1, wherein the housing has an element receiving pocket with a front wall adjacent to the first end of the housing to hold the splice element in each the bare fiber holder.

4. The connection system of claim 1, wherein at least one of the first and second bare fiber holders further comprises a fiber organizer disposed within the housing, wherein the fiber organizer comprises a comb structure includes an array of grooves, with each groove configured to guide an optical fiber disposed therein and a remote gripping region to remotely grip the plurality of first or second optical fibers at a distance from their bare ends.

5. The connection system of claim 1, wherein the first and second bare fiber holders are force balanced to allow creation of a dry splice optical connection between the plurality of first or second optical fibers.

6. The connection system of claim 5, wherein the force balancing is provided by a resilient element disposed between a portion of the fiber organizer and the holder housing; and an intermediate spring element disposed between a front portion of the fiber organizer and the splice element.

7. The connection system of claim 1, wherein the splice element of the first bare fiber holder and the splice element of the second bare fiber holder are formed of a low coefficient of thermal expansion silica material.

8. The connection system of claim 7, wherein the low coefficient of thermal expansion silica material is a net shape cast and cure silica material.

9. The connection system of claim 1, further comprising an optical coupling material disposed between ends of the first and second optical fibers.

10. The connection system of claim 1, wherein both the first bare fiber holder and the second bare fiber holder are ferrules.

11. The connection system of any of the previous claims, claim 1 wherein the connection system optically interconnects a plurality of first optical fibers to a plurality of second optical fibers.

12. The connection system of claim 1, wherein at least one of the first and second bare fiber holders is factory terminated on an end of an optical fiber cable containing at least one optical fiber.

13. The connection system of claim 1, wherein the first and second bare fiber holders are mated in the field to make the optical connection.

14. The connection system of claim 1 wherein the splice element comprises a funnel shaped entrance opening at an end of the at least one alignment channel.

15. The connection system of claim 1 wherein the splice element further comprises a rail disposed along each longitudinal edge of the splice body that includes one of a locking depression and a locking protrusion that is configured to mate with a corresponding feature when assembled together with a second exemplary splice element.
